(19) United States
(12) Patent Application Publication
(10) Pub. No.: US 2013/0082147 A1
(43) Pub. Date: Apr. 4, 2013

(54) Axial flux motor reaction wheel for spacecraft

(71) Applicants: Eloisa Mae De Castro, Lawrenceville, NJ (US); Michael A. Paluszek, Princeton, NJ (US)

(72) Inventors: Eloisa Mae De Castro, Lawrenceville, NJ (US); Michael A. Paluszek, Princeton, NJ (US)

(73) Assignee: PRINCETON SATELLITE SYSTEMS, INC., Plainsboro, NJ (US)

(21) Appl. No.: 13/573,754

(22) Filed: Oct. 3, 2012

Related U.S. Application Data
(60) Provisional application No. 61/542,464, filed on Oct. 3, 2011.

(51) Int. Cl. B64G 1/28

(52) U.S. Cl. 244/165

(57) ABSTRACT

The invention is for spacecraft reaction wheel with an axial flux dual Halbach rotor with an air coil stator. This wheel is more efficient and has fewer disturbances than a conventional reaction wheel with a brushless DC motor.

### CROSS-REFERENCE TO RELATED APPLICATIONS

This application claims the benefit of Provisional Patent Application Ser. No. 61/542,464, filed Oct. 3, 2011 by the present inventors, which is incorporated herein by reference in its entirety.

### FIELD OF THE INVENTION

The present invention relates to the attitude control of spacecraft.

### BACKGROUND OF THE INVENTION

Reaction wheels are the preferred method for controlling the orientation of a satellite. Satellites as small as CubeSats (1 kg satellites) and as large as the Hubble Space Telescope use reaction wheels.

Reaction wheels use permanent magnet brushless DC motors. The rotor has a set of Hall effect sensors that trigger when a magnet passes them. This signal is used to commute the motor, that is to change the currents in the stator windings.

There are hundreds of different DC motor configurations. Most are radial flux in which the magnetic flux vector is along the radius. The magnets may be surface mounted, embedded in magnetic steel or in slots. The coils are typically embedded in magnetic steel slots.

The motors discussed above are designed for high speed operation. When used for low-speed applications they are usually connected to the load via a gearbox. Gearboxes add flexibility along the axis of rotation. Gearboxes also add losses and mass.

The Hall sensors do not provide an accurate speed measurement at low speed. Because commutation only happens when a magnet passes a magnet pole it is not possible to determine the angle or speed between Hall sensor updates. As a result it is not possible to adjust the torque to compensate for static friction and disturbances that happen over short spans of a rotation period.

The presence of magnetic steel increases the losses in the motor making it less efficient. In addition magnetic steel leads to additional flux paths during operation. These additional paths lead to non-linear and undesirable torques. The magnetic steel also makes the wheel more massive and bulky.

These issues lead to a degradation of satellite performance. Thus there is a need for an improved system.

Andeen (U.S. Pat. No. 3,968,252 issued Jul. 6, 1976) attempts to improve the accuracy of the torquer output of a reaction wheel by using a torque measurement and applying a control to the difference between the commanded torque and desired torque. This does not deal with the problems at low speeds and does not compensate for the inherent torque disturbances due to the wheel design.

Stetson (U.S. Pat. No. 5,020,745, issued Jun. 4, 1991) attempts to improve low speed performance through a dither signal. As with Andeen, this does not deal with the significant torque nonlinearities in reaction wheel motors.

Goodzeit et al (U.S. Pat. No. 5,201,833, issued Apr. 13, 1992) uses a model following approach to improve the torque response of the reaction wheel. This approach has the same limitations as Andeen.

Alternative motor configurations have been proposed to improve the performance of electric motors as traction drives.

Curodeau (U.S. Patent Application US2012/0169154 A1, published Jul. 5, 2012) proposes an axial flux motor for vehicular applications. Although he mentions the use of Halbach arrays his design uses back iron that leads to losses and nonlinear torque response.

Post (U.S. Pat. No. 6,858,962, issued Feb. 22, 2005) is for an axial flux Halbach array motor/generator. This concept uses a complex scheme for mechanically changing the diameter of the motor. This design is impractical for the space environment.

Lin, et al (U.S. Pat. No. 6,011,337, issued Jan. 4, 2000) proposes an axial flux motor with two electromagnet units and one magnet unit affixed to the shaft. This allows each magnet to be engaged by both electromagnet units allowing for greater torque. This is a more complex scheme that would not work with a Halbach array which confines the magnetic flux to one side of the magnets.

Floresta, et al (U.S. Pat. No. 5,646,467, issued Jul. 8, 1997) proposes an axial flux DC motor with flux return plates on the stators. These flux return plates are a source of losses and undesirable in a low loss spacecraft reaction wheel that must have high efficiency due to the limited power available in satellites

The cited patents for both reaction wheels and axial flux motors do not solve the critical problems of smooth torque generation over the entire wheel speed range, low losses and simplicity required for spacecraft reaction wheels. This invention presents a solution to these problems.

### SUMMARY OF THE INVENTION

The present invention provides a reaction wheel for spacecraft.

The invention pertains to using an axial flux motor with an ironless stator and a Halbach magnet array to generate the magnetic flux. The stator uses a three phase winding without any backing iron. The control can use a combination of angle encoder measurements and current measurements to control the speed of the reaction wheel and to produce the desired reaction torque.

### BRIEF DESCRIPTION OF THE DRAWINGS

FIG. 1 is a diagram of reaction wheel;

FIG. 2 shows the electronics;

FIG. 3 shows the stator wire support

FIG. 4 shows the control system.

FIG. 5 shows the control system with the encoder.

### DETAILED DESCRIPTION

In the following description, for purposes of explanation, specific numbers, materials and configurations are set forth in order to provide a thorough understanding of the invention. It will be apparent, however, to one having ordinary skill in the art, that the invention may be practiced without these specific details. In some instances, well-known features may be omitted or simplified so as not to obscure the present invention. Furthermore, reference in the specification to “one embodiment” or “an embodiment” means that a particular feature, structure or characteristic described in connection with the embodiment is included in at least one embodiment of the invention. The appearances of the phrase “in an embodiment” in various places in the specification are not necessarily all referring to the same embodiment.

During the course of this description like numbers will be used to identify like elements according to the different views, which illustrate the invention.

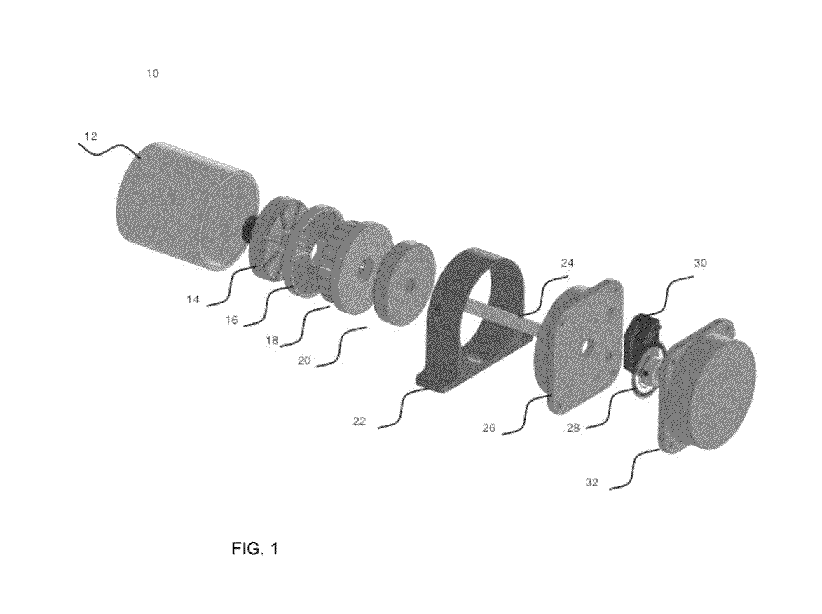

An embodiment of the invention is shown in FIG. 1. This diagram shows various components of the reaction wheel.

The reaction wheel assembly is shown in 10. Element 12 is the housing which provides structural support and conducts heat away from the motor.

The lower rotor assembly is 14. The wedge magnets are exaggerated for clarity. The magnets would be manufactured from a single piece of magnetic material and the magnet pole imposed on the assembly. The Halbach magnets may be at 90 degree angles, requiring four magnets per pole, 60 degree angles requiring six magnets per pole and 45 degree angles requiring eight magnets per pole.

The three-phase stator is element 16. It has three phase windings wrapped on a structure made of a thermally conductive material with nearly zero electrical conductivity.

The upper rotor assembly is 18.

The flywheel is 20. This adds rotational inertia and increases the momentum storage. A uniform disk is shown but a shaped disk can be used that has more mass at the rim and has spokes to support this mass. The design of such disks is well known.

The shaft is element 24. This is connected to a bearing assembly. The two magnet assemblies are fixed to the shaft and rotate with the shaft. The bearing assemblies are not shown in the diagram. The left of the shaft depends on the size of the reaction wheel.

The angle encoder disk, 28, and the digital reader is 30. The upper housing assembly is 32. The angle encoder measures the angle of the shaft. An absolute encoder provides and absolute measure and a relative encoder gives a relative measurement but a signal whenever the zero angle is crossed.

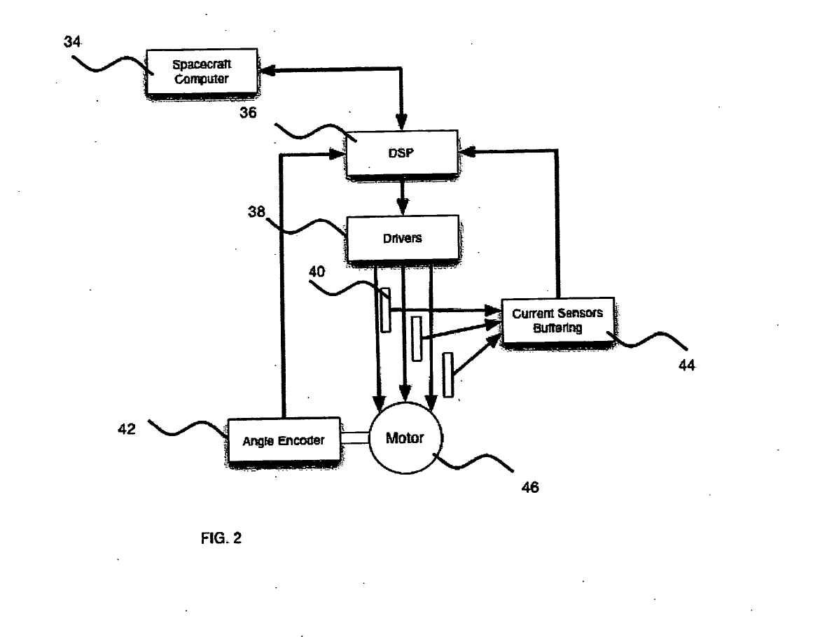

FIG. 2 is a diagram showing the wheel electronics. The reaction wheel assembly is controlled by the spacecraft computer, 34. The spacecraft computers sends a desired torque command to the reaction wheel digital signal processor, henceforth known as the DSP 36.

The torque commands generated by the computer control systems are sent to the digital signal processor, 36. A DSP is needed to perform the high frequency computations.

The DSP 36 sends switching commands to the drivers, 38, which interface with the axial motor coils on the stator, 16.

The phase current in each driver is measured by a Hall sensor, 40. These sensors should not be confused with the Hall sensors described above and used for commutation. The signals are buffered in 44 and fed back to the DSP 36.

The angle encoder, 42, is of the differential type. It provides a measurement of the shaft angle of the motor, 46.

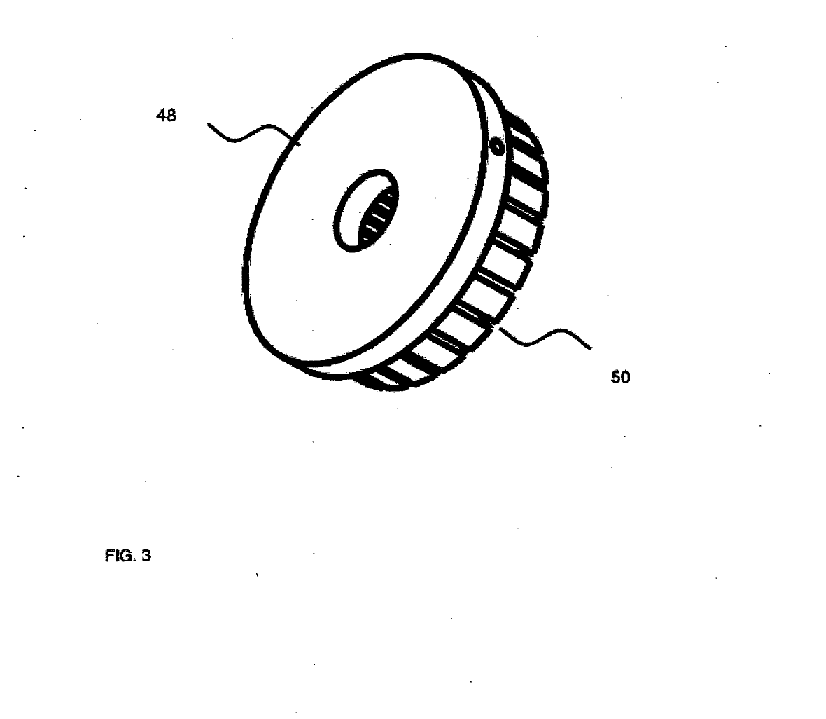

FIG. 3 shows the stator wire support. It consists of the support disk, 48 and the slots for the wires, 50. Since the stator is a non-magnetic material it does not produce the losses caused by magnetic steel slots. Alternative supporting arrangements may be used for winding the materials.

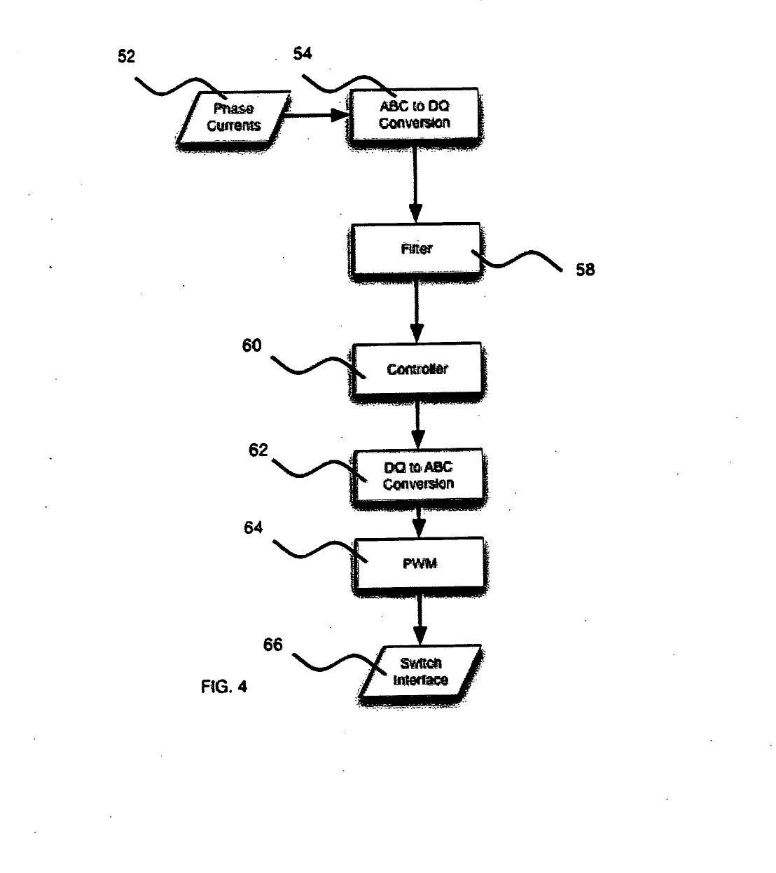

FIG. 4 is a block diagram depicting the control software for the reaction wheel.

The phase current measurements from the phase winding are converted into floating point numbers in 52. The 3 phase measurements are converted to direct quadrature (DQ) form in 54. The filters and controllers are written in DQ form.

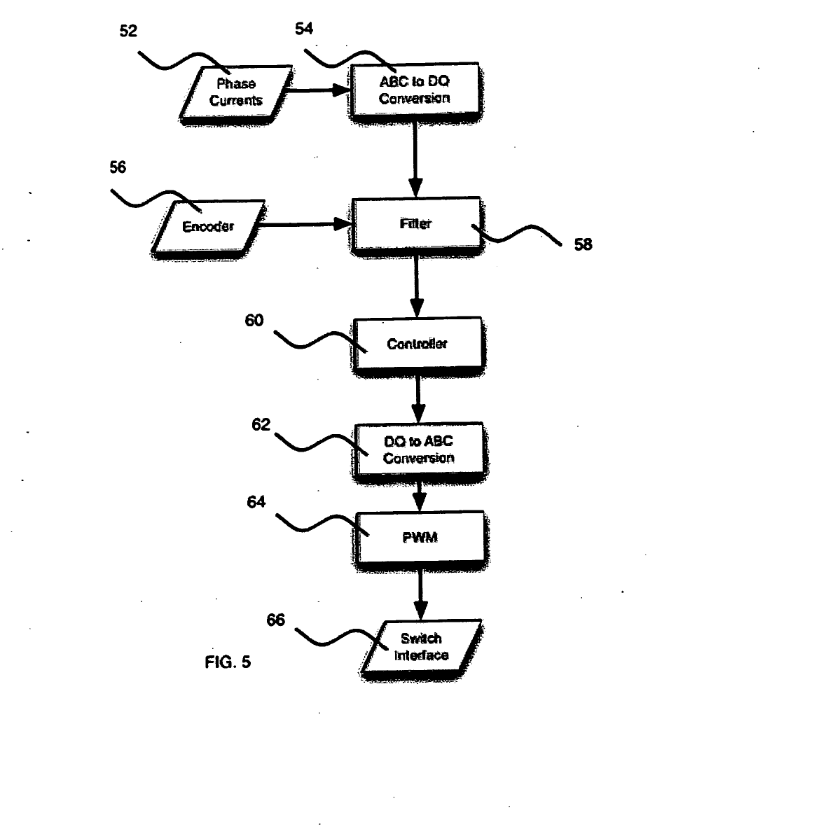

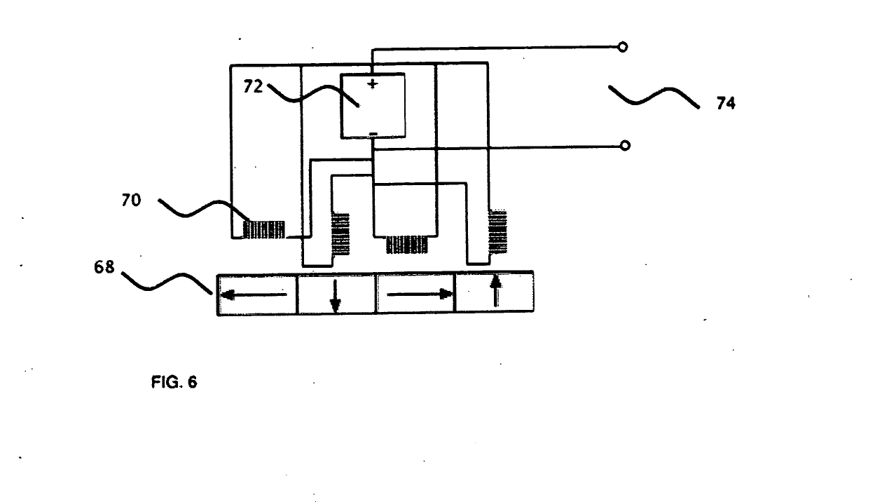

FIG. 5 shows the system with the addition of the angle encoder. The encoder measurement is converted to floating point in 56. The encoder and current measurements are combined in a filter in 58.

The measurements are used to generate the voltage signals in 60. The DQ outputs are converted to three-phase signals (ABC) in 62.

The three phase signals are used to drive a pulse width modulator (PWM) in 64. This connects to the semiconductor switches in 66.

The Halbach array may be composed of individual magnets fastened to an ironless backing material. Alternatively, the array may be made by pulse-magnetizing and disk of rare-earth magnetic material. FIG. 6 shows the pulse magnetization of a single Halbach pole. The Halbach Array, 68, which in this case is a 90 degree Halbach array, is magnetized by applying a high current to the solenoids, 70. The current is produced by a large capacitor, 72, which is charged by an external power source, 74. The pulse-magnetized Halbach array is simpler to assemble into the axial flux motor and mechanically more reliable. The pulse-magnetization fixture need only be built once for building any number of reaction wheels.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An axial flux motor reaction wheel comprising
a rotor with dual Halbach magnet arrays;
a stator with 3 phase windings wound on a thermally conductive non-magnetic material;
a flywheel to increase the momentum stored;
sensors to measure current in the phase windings;
a digital signal processor to generate the pulse width modulated waveforms for the phase windings;
a driver to interface with the phase windings; and,
a computer to control the digital signal processor.

2. The axial flux motor reaction wheel of claim 1, further including an angle encoder to measure rotor angle.

3. The axial flux motor reaction wheel of claim 1, further including an angle encoder to determine angular rate and angle.

4. The axial flux motor reaction wheel of claim 1, further including a continuous disk of magnetic material in which the Halbach configuration is imposed by pulse magnetization.
